(19) United States
(12) Patent Application Publication
(10) Pub. No.: US 2017/0054801 A1
(43) Pub. Date: Feb. 23, 2017

(54) METHOD, APPARATUS AND SYSTEM PERTAINING TO CLOUD COMPUTING

(71) Applicant: Anuta Networks, Inc., Milpitas, CA (US)

(72) Inventors: Srinivisa Beereddy, Fremont, CA (US); Praveen Vengalam, Fremont, CA (US); Amol Wate, Bangalore (IN); Kiran Sirupa, Santa Clara, CA (US); Chandra Guntakala, Austin, TX (US); Muni Prasad Thunuguntla, Bangalore (IN); Subbarayan Venkatesan, Plano, TX (US)

(73) Assignee: Anuta Networks, Inc., Milpitas, CA (US)

(21) Appl. No.: 15/342,074

(22) Filed: Nov. 2, 2016

Related U.S. Application Data
(63) Continuation of application No. 14/153,718, filed on Jan. 13, 2014.
(60) Provisional application No. 61/806,787, filed on Mar. 29, 2013.
(60) Provisional application No. 61/754,515, filed on Jan. 18, 2013.
(60) Provisional application No. 61/753,568, filed on Jan. 17, 2013.
(60) Provisional application No. 61/751,815, filed on Jan. 11, 2013.

(51) Int. Cl. H04L 29/08; H04L 12/66; H04L 29/12; H04L 12/46

(52) U.S. Cl. CPC H04L 67/1019; H04L 67/1017; H04L 67/1023; H04L 12/4641; H04L 12/66; H04L 61/106

(57) ABSTRACT

The present disclosure outlines a system, method, and apparatus for the design of network services, including the automatic sourcing an aggregatng of data on the available resources. In a further aspect, the present disclosure outlines a system, method, and apparatus for the allocation of cloud resources. In yet a further aspect, the present disclosure outlines a system, method, and apparatus for redirecting traffic through an alternative gateway.

### CROSS-REFERENCE TO RELATED APPLICATIONS

This application claims priority to U.S. Non-Provisional patent application Ser. No. 14/153,718 filed Jan. 13, 2014, which claims priority to U.S. Provisional Patent Application Ser. No. 61/806,787 filed Mar. 29, 2013, U.S. Provisional Application Ser. No. 61/754,515 filed Jan. 18, 2013, U.S. Provisional Patent Application No. 61/753,568, filed Jan. 17, 2013, and U.S. Provisional Patent Application. No. 61/751,815, filed Jan. 11, 2013. Each application is hereby incorporated by reference in its entirety.

### BACKGROUND OF THE INVENTION

Today's clients expect rapid delivery of services and are no longer willing to accept deployment service level agreement (“SLA”) of weeks or months. This places tremendous pressure on information technology (“IT”), which to meet this requirements, are increasingly deploying or relying on cloud data centers. In these cloud data centers, the Network is proving to be a significant bottleneck in the move towards the Enterprise Cloud Data Centers due to lack of automation.

Server virtualization is gaining widespread adoption and the virtualization technology and tools have made automation a possibility, thereby increasing the efficiency of server administrators. However, network administrators have to deal with varying level of multi-dimensional complexity with the existing technology and innovation providing little automation.

To process this request, the network administrator would have to process the following information.

Tenant Policy and Profile—Every tenant requesting service typically has a related or assigned policy/profile. Typically these policies are documented (or in some cases even undocumented) and interpreted by the network administrator. For instance, if the finance department requests a new application, the system administrator has to determine which users have access to the application, which can be determined on a diverse range of parameters. This process can be repeated each time a new application is deployed, new user (s) are added or policies related to applications are updated.

Network Parameters—Once a network administrator deciphers the policy definitions and service description for the tenant, they then define the network profile to provision. This can encompass various network parameters such as quality of service (“QoS”), security, virtual local area networks (“VLANs”), network protocols etc., and also comprise different network elements to provision.

Capacity Planning—Most networks are overprovisioned with the hope that there is little contention for the network resources and the guaranteed SLAs are met. While such overprovisioning might guarantee SLAs, it also signifies that the network infrastructure is not being efficiently utilized. This lack of efficiency increases the Total Cost of Ownership (“TCO”) while reducing the Return on Investment (“ROI”) of the network.

Multi-vendor environment—in the case of a multi-vendor data center, the network administrator is also confronted with the non-trivial task of figuring out the capabilities of the network elements in the data path for the service being provisioned. If the enterprise has acquired the best of breed technology, chances are that these network elements are procured from various vendors which bring their own feature sets and complexity to the equation e.g. different types of devices (routers, switches, firewalls, and load balancers), different versions of software and CLI's etc.

Physical and virtual elements—Besides the multi-vendor variance in a network, another aspect that a network administrator has to contend with is the increasing number of virtual elements in the network. Each virtual element adds to the complexity that the network administrator is already dealing with and the problem to manage these virtual elements increases significantly in complexity since multiple instances of virtual elements can be created.

Further to the design and allocation limitations outlined above, it is important that data center offering multi-tenant network services provide isolation among tenants. VLANs are used to provide such isolation at L2 level, however, the number of VLANs under a L3 domain is limited to 4096 which becomes a limiting factor to have more tenants provisioned on a given network infrastructure.

A typical networking infrastructure comprises a Core layer, a Distribution layer, an Access layer and a Virtual Access layer. Hosts in this example are connected via the Access layer. In a virtualized environment, hosts run hypervizor and contain a Virtual Access Switch to which all the virtual machines (“VMs”) running on the host will be attached to. Tenants request a network with certain number of VMs. Each of these tenant network is allocated a VLAN.

VLANs can span multiple switches and they can cross the hierarchical boundaries (core, distribution and access). When a VLAN spans across multiple hierarchical boundaries, they are called End-to-End VLANs (“EEVLAN”). VLANs that do not span the hierarchical boundaries, they are called local VLANs (“LVLAN”). LVLAN can also be limited to a single switch.

In a data center offering services for multiple tenants, each tenant can ask for multiple networks, each one these networks are allocated a VLAN that provides the security and isolation from other networks. However, VLAN space is limited to 4096 VLANs, so allocating a EEVLAN for each tenant network limits how many tenant networks can be configured on a given network infrastructure.

### BRIEF SUMMARY OF THE INVENTION

The present disclosure aims to address to the existing shortcomings known in the art, and includes the following aspects:
a method, computer executable code stored on an non-transient computer readable medium, and an apparatus for the design of network services;
a method, computer executable code stored on an non-transient computer readable medium, and an apparatus for Virtual Machine Allocation in a cloud computer system;
a method, computer executable code stored on an non-transient computer readable medium, and an apparatus for directing traffic through an alternative default gateway; and
a method, computer executable code stored on an non-transient computer readable medium, and an apparatus for conserving VLANs in a data center network.

### BRIEF DESCRIPTION OF THE DRAWINGS

The novel features believed characteristic of the disclosed subject matter will be set forth in the claims. The disclosed subject matter itself, however, as well as a preferred method, further objectives, and advantages thereof, will best be understood by reference to the following detailed description of an illustrative embodiment when read in conjunction with the accompanying drawings, wherein:

FIG. 1 is a flow chart diagram illustrating an exemplary system of the alternative default gateway aspect.

FIG. 2 is a flow chart diagram illustrating an exemplary system of the alternative default gateway aspect, wherein the switch port associated with the default gateway is disabled.

FIG. 3 is a flow chart diagram illustrating an exemplary system of the alternative default gateway aspect, wherein the alternative default gateway is introduced.

FIG. 4 is a flow chart diagram illustrating an exemplary system of the alternative default gateway aspect, wherein the data path associated with the default gateway is disabled.

FIG. 5 is a flow chart diagram illustrating an exemplary system of the alternative default gateway aspect, wherein the default gateway is disabled.

FIG. 6 is a flow chart diagram illustrating an exemplary system of the alternative default gateway aspect and exemplary applications.

FIG. 7 illustrates exemplary network feature building blocks as disclosed in the network service design aspect of the present disclosure.

FIG. 8 illustrates an exemplary Network Service with Firewall and Load Balancer as disclosed in the network service design aspect of the present disclosure.

FIG. 9 illustrates an exemplary Attribute Control of Load Balancer as disclosed in the network service design aspect of the present disclosure.

FIG. 10 illustrates an exemplary Network Feature Services Selection as disclosed in the network service design aspect of the present disclosure.

FIG. 11 illustrates a further exemplary Network Feature Services as portrayed on a GUI interface.

FIG. 12 illustrates one embodiment of the present disclosure pertaining to a network.

FIG. 13 illustrates one embodiment of the present disclosure Global VLANs.

FIG. 14 illustrates one embodiment of the present disclosure being Local VLANs.

FIG. 15 illustrates one embodiment of the present disclosure wherein the Tenant VMs are located on a single host.

FIG. 16 illustrates one embodiment of the present disclosure wherein the Tenant VMs are located on Multiple Hosts.

This disclosure describes, and illustrates, various embodiments of the invention along with some variations of the various embodiments. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

### DETAILED DESCRIPTION OF ILLUSTRATIVE EMBODIMENTS

Reference now should be made to the drawings, in which the same reference numbers are used throughout the different figures to designate the same components.

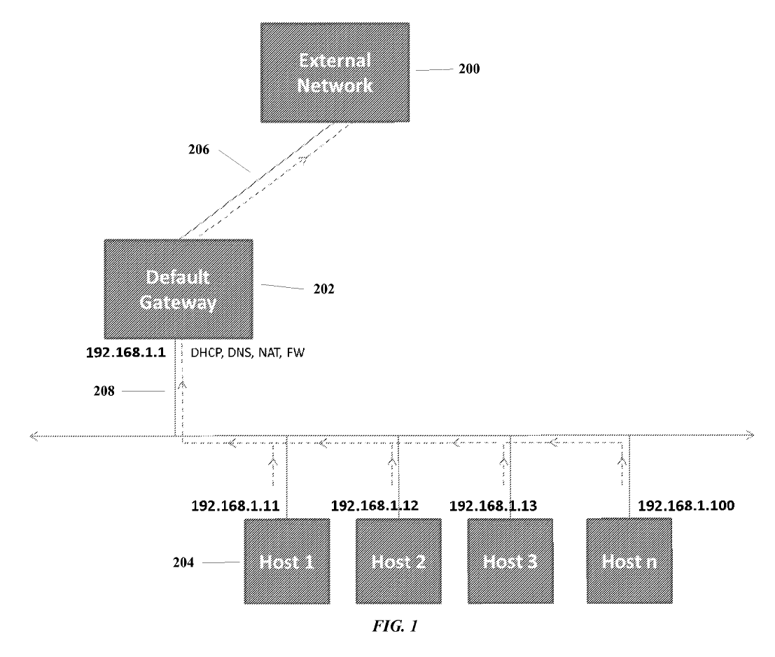

FIG. 1 illustrates one embodiment of the present disclosure wherein the external network 200 is connected 206 via a connection 208 to a plurality at Hosts 204 (with differing IP addresses) via the default gateway 202.

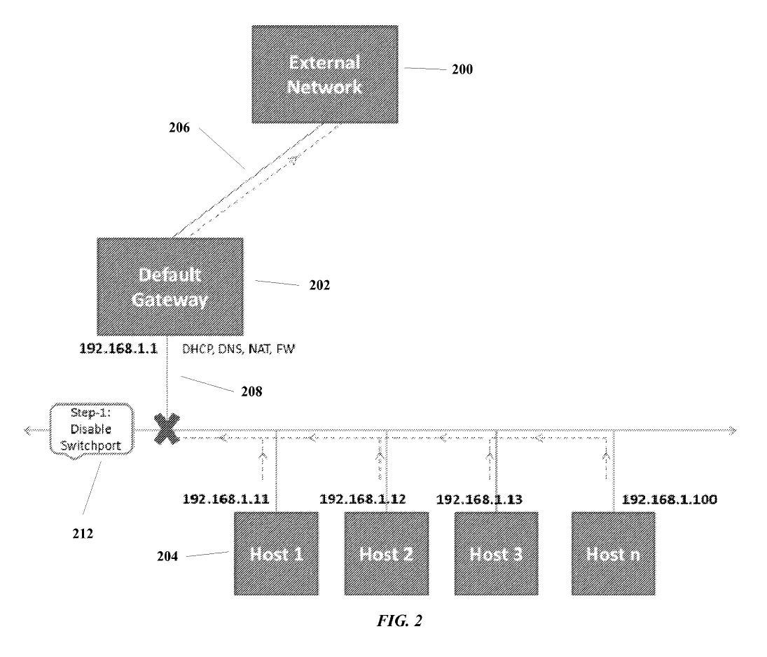

FIG. 2 illustrates one embodiment of the present disclosure wherein the external network 200 is connected via a connection 206 to the default gateway 202, the default gateway 202, is connected 208 to a switchport 212, and the switchport 212 is connected to a plurality of hosts 204. The example further illustrates that the switchport 212 is disabled with no traffic flow from the hosts to the external network 200.

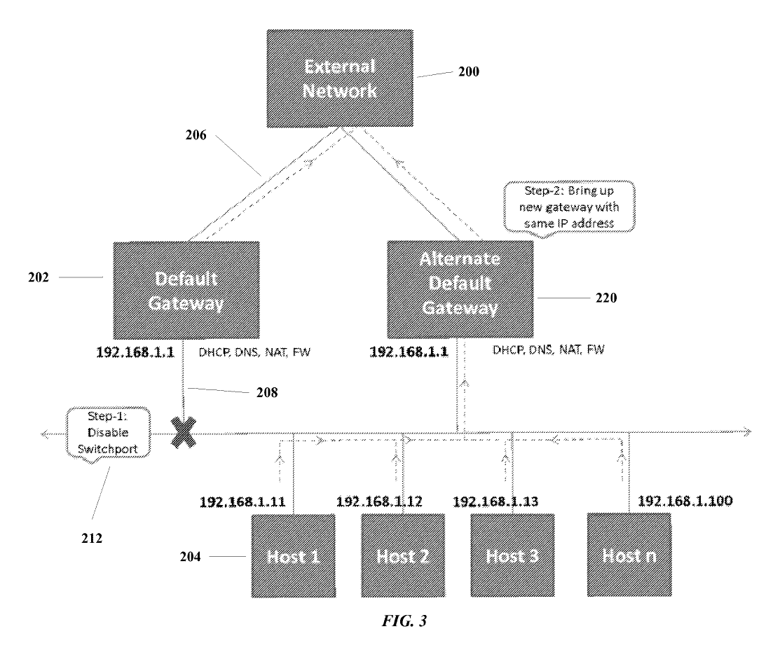

FIG. 3 illustrates one embodiment of the present disclosure wherein the external network 200 is connected via a connection 206 to the default gateway 202, the default gateway 202 is connected 208 to a switchport 212, and the switchport 212 is connected to a plurality of hosts 204. The example further illustrates that the switchport 212 is disabled, as well as an alternative default gateway 220 being connected to the hosts 204 and the external network 200.

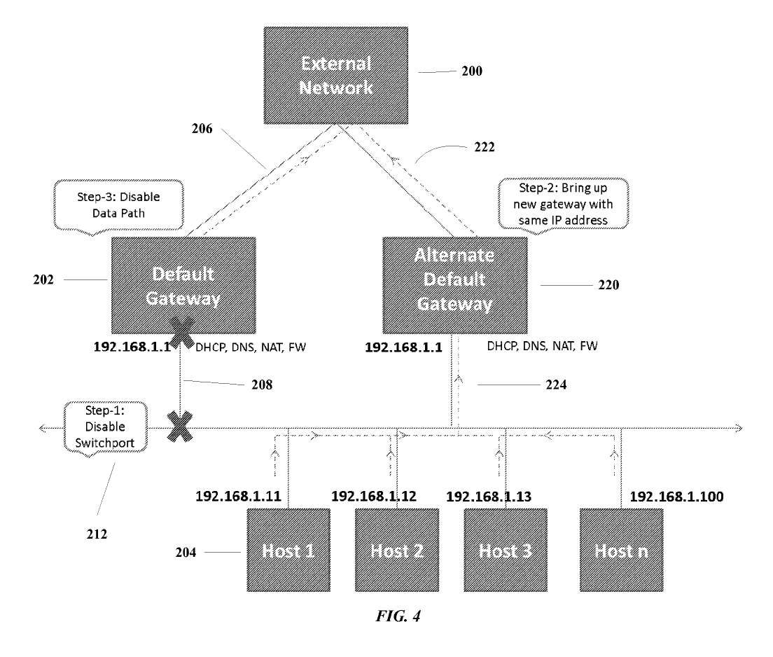

FIG. 4 illustrates one embodiment of the present disclosure wherein the external network 200 is connected via a connection 206 to the default gateway 202, the default gateway 202 is connected 208 to a switchport 212, and the switchport 212 is connected to a plurality of hosts 204. The example further illustrates that the switchport 212 and the connection 208 between the switchport 212 and the default gateway 202 are disabled. The alternative default gateway 220 provides a connection 222 between the hosts 204 and a connection 224 to the external network 200.

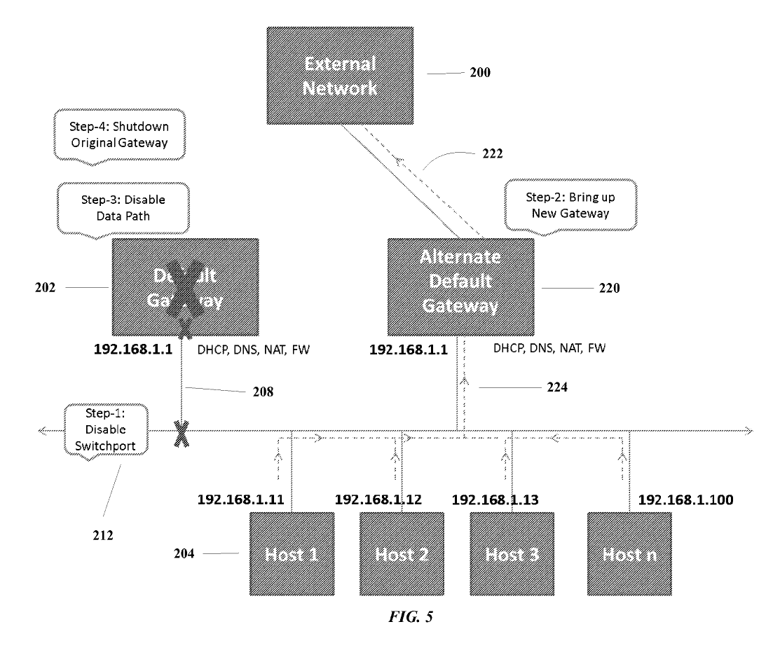

FIG. 5 illustrates one embodiment of the present disclosure wherein the external network 200 is not connected to the default gateway 202. The default gateway 202 is connected 208 to a switchport 212, and the switchport 212 is connected to a plurality of hosts 204. The example further illustrates that both the switchport 212, the connection between the switchport 208 and the default gateway 202, and the default gateway are disabled. The alternative default gateway 220 provides a connection 222 between the hosts 224 and the external network 200.

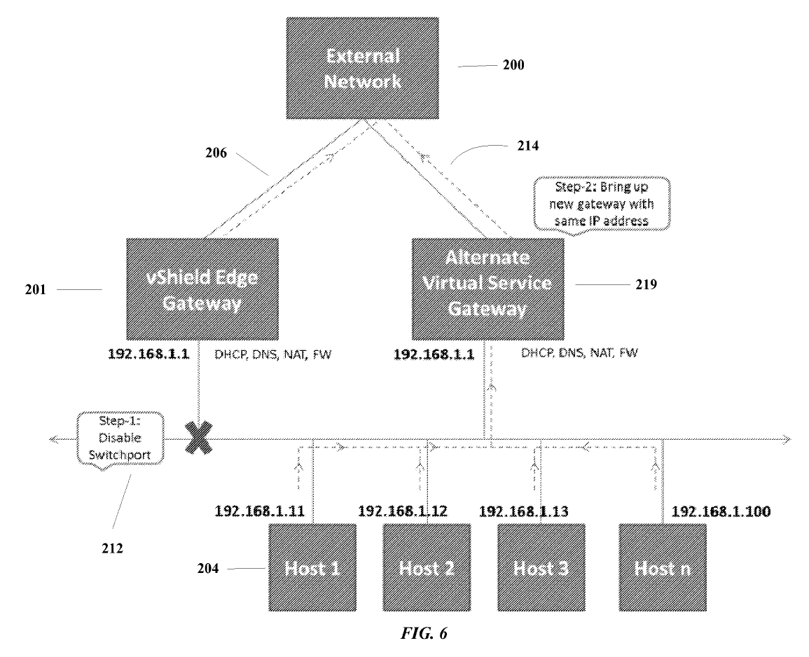

FIG. 6 illustrates a further embodiment of the present disclosure wherein the external network 200 has a connection 206 to an exemplary vShield Edge Gateway 201, which is connected 208 to a disabled switchport 212, and the disabled switchport 212 is connected to a plurality of hosts 204. The example further illustrates that the traffic between the hosts and the external network is facilitated by an alternative virtual service gateway 219.

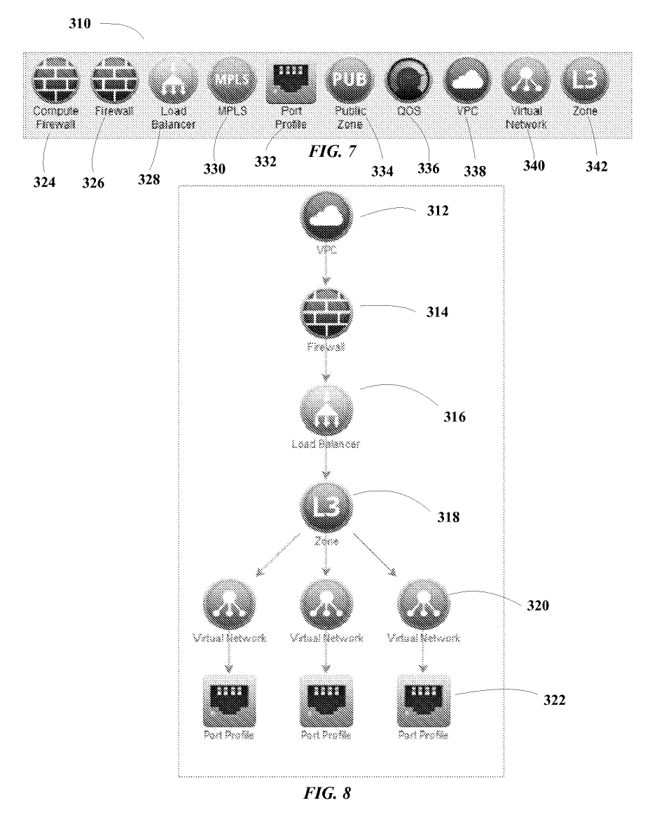

FIG. 7 illustrates an embodiment of the network services design as could be presented on a GUI. The interface presents exemplary building blocks 310, comprising a compute firewall 324, a firewall 326, a load balancer 328, a MPLS 330, a port profile 332, a public zone 334, a QoS 336, a VPC 338, a virtual network 340, and a L3 zone 342.

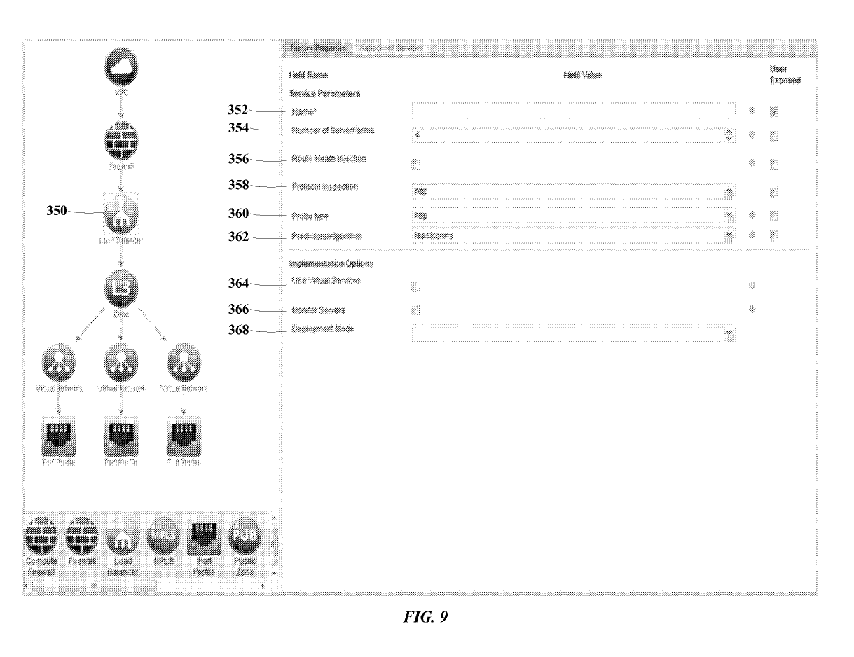

FIG. 8 illustrates an embodiment output of the present disclosure, wherein the user, administrator, etc. has selected a VPC 312, with a firewall 314, load balancer 316, L3 zone 318, and a plurality of virtual network 320 and port profiles 322.

FIG. 9 illustrates an exemplary GUI screenshot of the present disclosure pertaining to a load balancer service selection 350, wherein the user for the interface can enter values, or make a selection, for the fields of “name” 352, “number of server farms” 354, select “route health injection” 356, “protocol inspection” 358, “probe type” 360, and “prediction/algorithm” 362. In addition, this exemplary screen short includes a pick box “use virtual service” field 364 and “monitor servers” field 366, as well as a “deployment mode” field 368.

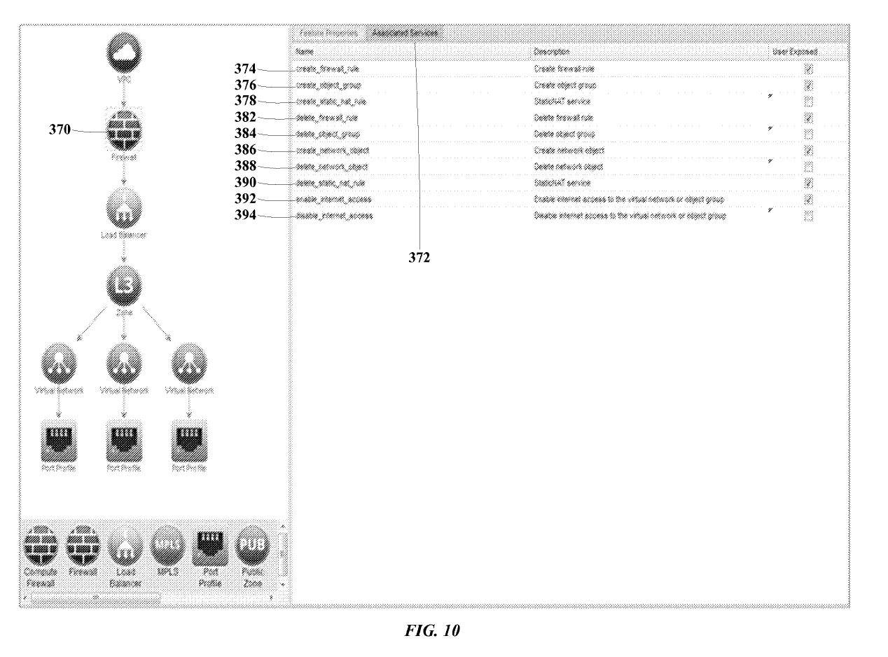

FIG. 10 illustrates an exemplary GUI screenshot of the present disclosure pertaining to a firewall service selection 370, and an advanced services tab 372. This exemplary screenshot includes a pick box selection for the fields “of create firewall rule” 374, “create object group” 376, “StaticNat service” 378, “delete firewall rule” 382, “delete object group” 384, “create network object” 386, “delete network object” 388, “StaticNat service” 390, “enable internet access to the virtual network or object group” 392, and “disabled internet access to the virtual network or object group” 394.

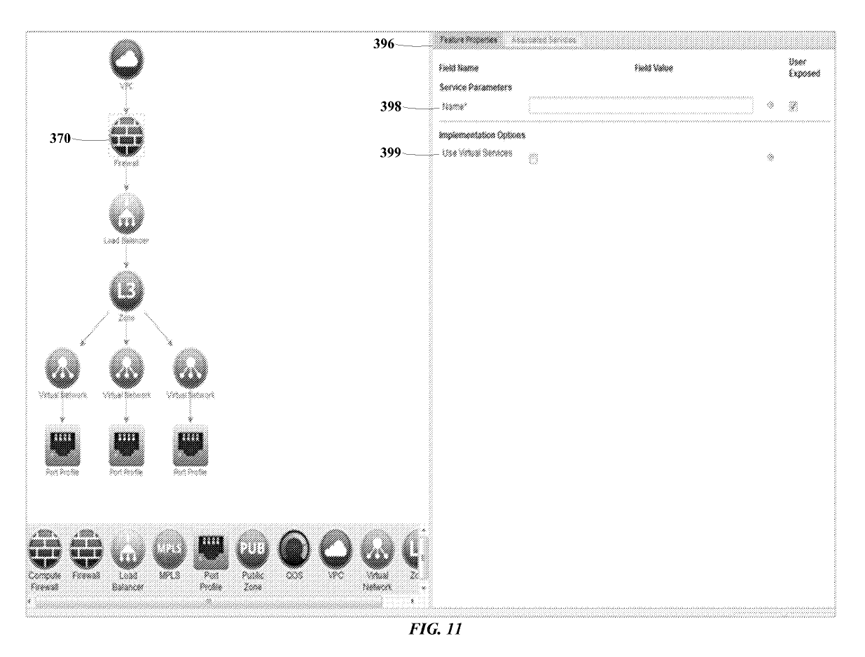

FIG. 11 illustrates an exemplary GUI screenshot of the present disclosure pertaining to a firewall service selection 370, and the feature properties tab 396. This exemplary screenshot includes the fields of name 398, and a pick selection field of use virtual services 399.

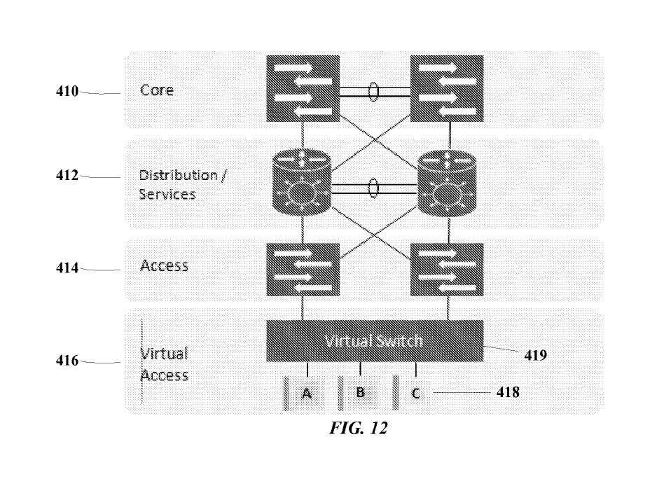

FIG. 12 illustrates an exemplary networking infrastructure comprising a core layer 410, a distribution layer 412, an access layer 414, and virtual access layer 416. In this example, a plurality of hosts 418 is connected to the Access layer 414 via a virtual switch 419.

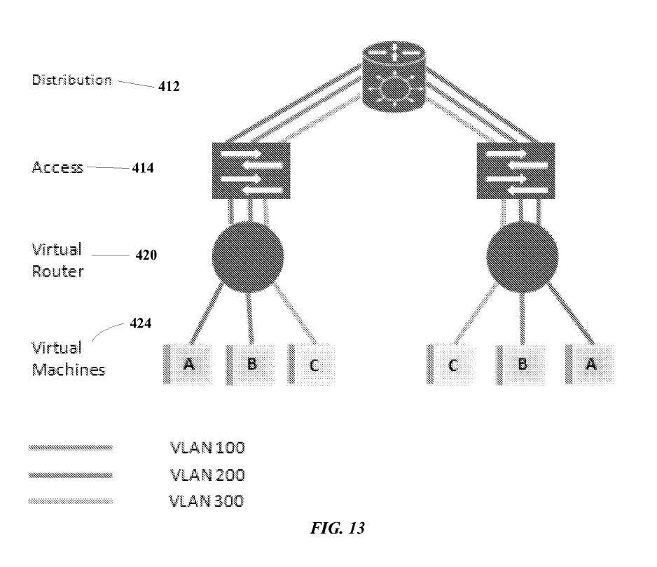

FIG. 13 illustrates an exemplary networking infrastructure including a distribution layer 412 connected to a plurality of access layers 414. Each access layer is in turn connected to a virtual router 420, with each virtual router 420 connecting to a plurality of virtual machines 424.

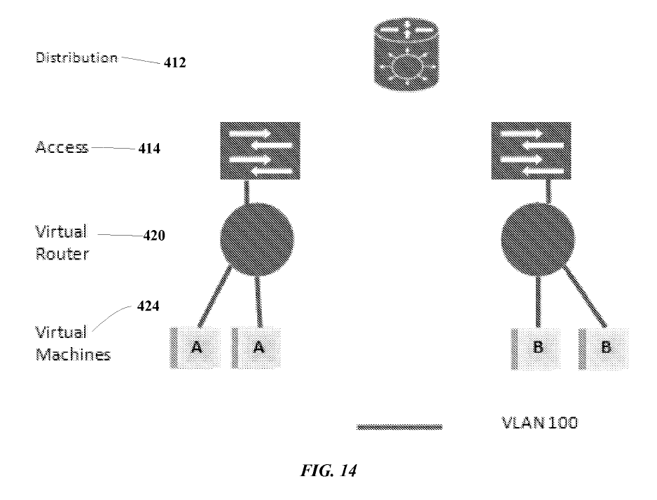

FIG. 14 illustrates an exemplary networking infrastructure including a distribution layer 412 but no connection to the access layers 414. Each access layer is in turn connected to a virtual router 420, with each virtual router connecting to a virtual machines 424.

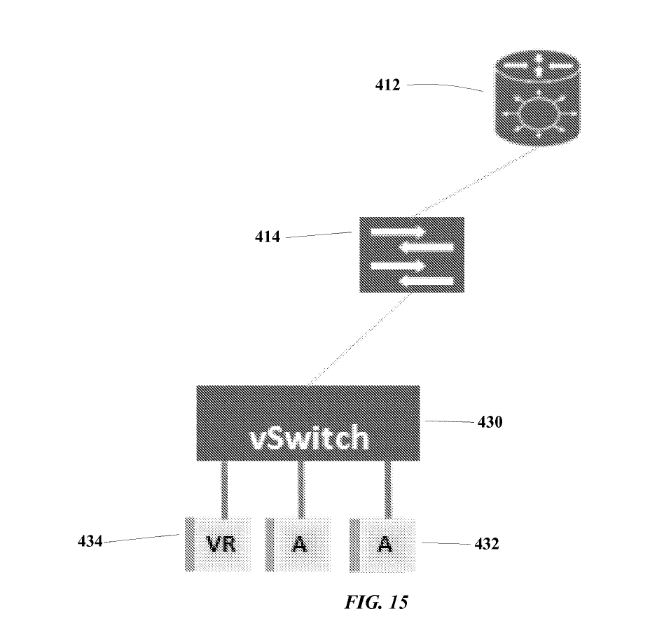

FIG. 15 illustrates an exemplary networking infrastructure including a distribution layer 412 connected to a access layers 414. Each access layer 414 is in turn connected to a vSwitch 430, which is in turn connected to a plurality of hosts 432 and VR 434.

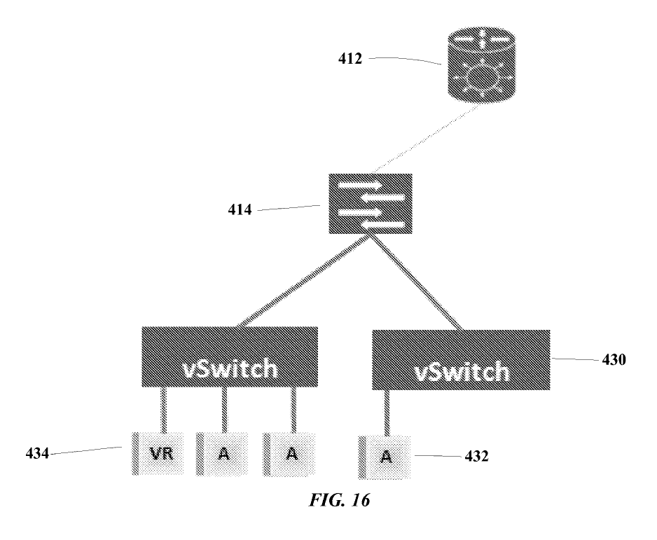

FIG. 16 illustrates an exemplary networking infrastructure including a distribution layer 412 connected to a access layers 414. The access layer is in turn connected to a plurality of vSwitch 430, which in turn connected to a plurality of hosts 432 and VR 434.

One aspect of the present disclosure is a method and apparatus for designing network services using a service designer.

One embodiment of this aspect provides a means for data center providers (that offer multi-tenant cloud services) to provide different kinds of services to various tenants based on their clients business needs and the infrastructure the service provide has available. For example, a service provider's network infrastructure provides firewall and load balancer services, and it intended to offer these services to potential or existing tenants. However, not all the tenants will require these services, so the provider needs to offer multiple services with varying features to the tenants. Traditionally this process involves lot of manual design of these services and mapping the services to the network infrastructure. This process can be further complicated in circumstances where the data center provider prefers to (or is required to) utilizes a range of infrastructure variations. For example, a firewall service can be produced by multiple vendors with varying degree of capabilities such as throughput, monitoring capability, etc. The present disclosure provides a means to provide these services to tenants without exposing the actual implementation.

The present embodiment discloses a method to separate the task of designing a service from the underlying physical network. In this embodiment, a graphical user interface (“GUI”) allows users to build a logical network service topology by dragging and dropping various network service building blocks such as firewalls, load balancers, virtual networks, and QoS policies onto a drawing canvas. The user is then also able to connect these service nodes to define the desired topology.

An embodiment of the designing network services aspect is capable of extracting the underlying network elements based on the common attributes across all the vendors and presents a logical view for the system administrator. The embodiment therefore enables a system administrator to design the network services within a shortened period, and then further enables the network services to be published to end-users as part of a service catalog. Accordingly, the present embodiment greatly simplifies the ease as which cloud administrators can design service-provider packages by enabling attention to be focused exclusively on the design with the present aspect simplifying the process of dealing with a myriad of combinations of network elements and features.

In addition to selecting basic networking features (such as firewalls and load balancers as part of the logical network service), embodiments of the present aspect enable providers to control the capabilities of these features that are exposed to end users. These controls can include the ability to select which attributes can be exposed to end users for further customization, the ability to select default values for an attribute, the ability to specify if an attribute is updatable, and the ability to specify if an attribute can be set or read-only. For example, a load balancer feature can have an attribute to specify probe type. The possible values include: ‘http’, ‘https’, ‘tcp’, ‘icmp’, and ‘none’. The service designer can control whether the attribute ‘probe type’ can be exposed to the end user, and whether it is exposed, whether it has default value such as ‘http’, and whether it can be updated, in which case the end-user can change the value from a default to some other permitted value. Also, the attribute can be made read-only in which case the end user can see the value of ‘probe type’ but cannot change it. In addition, some operational data can be designated as ‘read-only’ for the end user. This type of data typically includes monitoring statistics generated by the system.

One embodiment of the present aspect offers additional services that are specific to the feature in question. For example, a firewall feature offers associated services such as creating a firewall rule, deleting firewall rules, creating a service policy, etc. In addition to controlling the attributes of a network feature, embodiments of the present disclosure enable a service designer to control which operations are allowed on a particular feature and which operations can be exposed to the end user.

Network features represented in the present embodiment can be implemented by a networking device in the infrastructure. The cloud, provider may have diff choices to implement a network feature. For example, a firewall feature can be implemented by a physical appliance, by a line card in a chassis or by a virtual appliance. Also, these implementation choices offer different levels of service. Embodiments of the present disclosure enables service designers to offer differentiated services to their end users.

Furthermore, a service designer embodiment of the present aspect can include a rule engine that validates the network design with the addition of every service element. For example, when the user places a load balancer outside of the firewall, an exception is generated. This ensures that be practice designs are followed, thus increasing compliance for cloud, networks. The present embodiment can also include a pre-defined template based on standard industry designs to further accelerate network service design. The ability of the present aspect to self-recognize complementary services, and/or non-complementary services across a range of products is a key differentiator when compared to existing technology.

Embodiments of the present aspect can provide a unified user interface simplifying service template design creation, enabling network administrators to perform tasks without the need to switch between command line interfaces (“CLIs”), web portals, and administrative consoles. One embodiment of the present disclosure utilizes a GUI to allow drag-and-drop creation using pre-defined service items which dramatically simplifies the creation of complex network configurations across multiple devices and vendors.

Using an embodiment of the present aspect, a network administrator can easily create a service catalog which would represent different service offerings for the tenant/business consumer. Each catalog item can be granularly defined to present different capabilities to the end user e.g. a Gold Service definition could include high bandwidth QoS, load balancers, and firewalls while a Silver Service definition might reduce the QoS bandwidth policy and remove the firewalls. This catalog can be easily created using drag and drop mechanisms and simplifies the creation of any custom policy as well.

One of the most complex stages for a network administrator is the actual orchestration of the network services. As indicated before, this step requires a network administrator to have expertise spanning multiple vendors, protocols and technologies. Along with knowing what to provision, a network administrator has to also have an understanding of where to provision the services.

When a tenant selects a specific catalog, one embodiment of the present aspect can dynamically validate the logical topology and determine the best possible network infrastructure. This validation can be based on resource availability along with capability, operational health and policy definitions. One embodiment of the present aspect automates a sophisticated multi-phase operation consisting of hundreds of commands across multiple devices, hypervisors, protocols, and vendors.

One embodiment of the present aspect is capable of orchestrating network services through a model driven Network Abstraction Engine that contains implementation details of how services are implemented across supported devices and technologies. This embodiment can leverage a model driven system to define operational implementations and to allow for support across a wide variation of combinations of topologies, service implementations, protocols, vendors, and interface versions.

The present disclosure also includes a “VM allocation in a cloud” aspect that addresses the existing shortcomings in the manner by which cloud providers allocate resources. This aspect builds upon the inventorying and aggregating computations performed as part of the service design aspect, to determine a resource allocation based upon the client, administrator, and user requirements.

An embodiment of the present aspect contains instructions for performing the steps of, and/or a methodology as presented below.

The system receives an input ordering the systems componentry/resources/parameters in terms of importance. For example, if CPU is more important than RAM, and RAM is more important than bandwidth, the ordering will be <CPU, RAM, bandwidth>. In general, there may be multiple resource types and all resource types are ordered.

One embodiment of the present aspect computation steps is as follows:

Let m be the different types of resources available. If only CPUs and RAM are of consideration, m=2; if bandwidth also is to be considered in addition to CPUs and RAM, then m=3, etc.

For this purposes of this embodiment, Let S1, S2, . . . Sn, be the n servers where the VM requests can be allocated.

Server Si has two vectors:

For this embodiment AVi represents a vector of resources that is available at server Si.

For one embodiment, ALi represents a vector of resources allocated at server Si (and therefore these are unavailable for allocation to new requests).

In one example A server S has 16 CPUs, 32 GB of RAM and 12 Gbps of bandwidth available. Its capacity can be represented by a vector <16, 32, 12> and m=3. The server receives VM request for 2 CPUs, 8 GB RAN and 3 Gbps of bandwidth. Thus the unallocated resources for server S are 14 CPUs (16 minus 2), 24 RAM (32 minus 8), and 9 bandwidth (12 minus 3) and will be represented as AV=<14, 24, 10> and AL=<2, 8, 3>.

Proceeding with the example, the system receives a single request Reqj whose resource requirement is denoted by vector RRj=<Rj,1, Rj,2, Rj,3, Rj,m> for VM allocation where Rj,x is the number of units of the xth resource type needed for the VMs. For example, if RRj=<3, 8, 5>, then this request needs 3 units of first resource type (CPU in our example), 8 units of second resource type (RAM in our example), and 5 units of resource type 3 (bandwidth in our example).

One embodiment of the present aspect stores all servers' available and allocated vectors as vectors in a single location.

In one embodiment, the system allocates resources on the basis of first or best fit analysis. This involves starting from the first server (of the sorted list of servers), and searching linearly for the first server whose AV vector is greater than or equal to the resource requirements of the VM request. Let Sk be the first source in the sorted list such that AVk>=RRj. After Reqj is allocated, the vectors AVk and ALk need to updated to reflect that the fact that Reqj has been allocated to Sk. [AVk=−RRj; ALk=+RRj.]

Let us consider a sample situation: assume that AVi≧SRj. [In other words, each component of AVi is greater than or equal to the corresponding component of SRj.] Now, if some component of AVi is equal to the corresponding component of SRj and other components of AVi are significantly larger than the corresponding components of SRj, then the updated AVi vector has one component which is zero. Clearly, this server will be unusable for future allocations until one of the allocated VMs terminate and release resources so that the component that had zero available resource units has non-zero quantity.

In a further embodiment, the system allocates resources on the basis of at least one of the following analysis methods.

Worst fit analysis: This involves starting from the last server of the sorted list and allocate. All steps are similar to that of the first fit method except for the order in which the system computes the allocation.

Random fit analysis: This involves selecting from among the available servers a server with sufficient resources and allocate demand as necessary.

Round robin allocation: This involves ordering all the servers in a single order (randomly ordered or based on resource availability) and the ordering is in a circular manner. Thus, the immediate successor of the last server in the list is the first server in the list (in a manner similar to the modulo operation). The system searches for the next available server starting from the server next to the one that was allocated to the last request (Initially, the first server from the sorted list is used), and finds the first server whose available resources are sufficient for the request (If none exists, the system will continue the repeat the analysis starting from the first server). This server is allocated to the request and the system remembers this server so that, for the next request, the system starts the search from the immediate successor of this server.

Instance 1: If a single request Reqj is to be handled (allocated), the problem is easy: the system sorts all servers in increasing order using vector comparisons. Best fit will be equivalent to first fit and worst fit is another option to consider. In the case of worst fit, the goal is to allocate to the server that has the largest unallocated resources so that what is left over after allocation can be useful for a future request.

Instance 2: In this case, AVi≧RRj for all values of i. Thus a single server cannot serve the needs of the request. In other words, for each i, there exists at least one component of AVi that is less than the corresponding component of RRj.

Option 1: Partition RRj into one or more equal sized partitions and allocate each element, of the partition separately using either first fit or worst fit. If all elements of the partition can be allocated, then this request is allocated. If at least one element of the partition cannot be allocated, then the embodiment stops and either outputs that allocation cannot be made or partitions the request into more elements and tries again.

Option 2: The embodiment finds the server with maximum AV value, allocates as much of AV of that server to the request, and any remainder is allocated recursively.

Instance 3: Multiple VM requests have arrived and an embodiment need to allocate all requests.

Option 1: The service sorts all the requests in increasing order (using vector comparisons as before). An embodiment starts with the largest request, allocates it using instance 1. Then goes to the next request in the sorted list and allocates using instance 1. In this way an embodiment exhausts the list of requests.

Many variations are possible in all cases. For example, where there is a need to choose from several choices, an embodiment can choose either randomly, in a round robin fashion, or based on other criteria such as scalar sum of all components.

Instance 3 is the hardest of all and the problems are very hard to solve. An optimal solution can be found by using a brute force method, but will consume lots of time. Possible approaches for optimal allocation may be tried using integer Linear Program formulations (again taking lots of time) or approximations based on Linear Programming.

In a further embodiment, each resource availability has a binary value (0 or 1 corresponding to either the resource is available or not), this represents a resource type having infinite units of that resource. This binary value, when allocating (decrementing available resource units) or reallocating (incrementing available resource units), the number does not change. For example, High Availability (“HA”) is an instance of such a resource type: Either one server pod has HA or it does not.

In a further embodiment, it is permissible to partition REQ into two subrequests REQ1 and REQ2 so that the two subrequests can be allocated to two different servers. This embodiment can be applicable in cases where the resource requirements of a single request REQ cannot be accommodated in a single server.

In this case, an embodiment chooses two servers S1 and S2 such that the combined resource availabilities of S1 and S2 are sufficient for the request. Thus RR≦AV1+AV2.

Case (a): Splitting REQ into REQ1 and REQ2 can be done arbitrarily.

In case (a), REQ1=component-wise-minimum-of (AV1,REQ) and REQ2=REQ−REQ1.

Now, REQ1 is allocated to S1 and REQ2 is allocated to S2.

Case (b): Only certain ways of splitting are allowed: For example, even splitting: REQ1=REQ2=½*(REQ) or REQ1=alpha*REQ and REQ2=(1−alpha)*REQ for an arbitrary constant alpha in the range 0 to 1. In such a case split REQ into REQ1 and REQ2 as per the rule and then assign each of the two REQ1 and REQ2 as two separate requests. This can be extended to the case where the single request is partitioned into more than two sub-requests also in a similar manner.

The present disclosure also provides an aspect detailing a method of redirecting network traffic through an alternative default gateway.

System embodiments of this aspect typically comprise a default gateway, alternative default gateway, switch port and at least one Host.

For the purposes of this disclosure, the term “a default gateway” represents any apparatus method or means by which multiple computer hosts in the same Local Area Network (LAN) are connected to outside networks. All the IP traffic originating from the hosts is sent to the default gateway router. Embodiments of the default gateway include both physical and virtual routers.

A default gateway is the fundamental building block to any IP based communication network. A default gateway consolidates all the traffic from multiple hosts through a central location and avoids the need to build routing intelligence at each and every host. The default gateway also offers functions such as DHCP, NAT and DNS functionality. In addition, the default gateway is the most effective position in the network to enforce security using firewall rules.

In certain scenarios there is a need to introduce an alternative default gateway. However, when an alternate default gateway is introduced, it is a non-trivial task to update numerous hosts to now send the IP traffic to the alternate default gateway. The problem is more complicated by the variety of hosts' operating systems and the management interface for each host.

For the purposes of the present disclosure the term “alternative default gateway” represents the new gateway introduced into a network, and to which hosts send network traffic after the traffic redirection has occurred. Embodiments of the alternative default gateway include, both physical and virtual routers.

A switch port is part of physical or virtual switch to which a gateway or hosts are connected. A switch port can be a physical or virtual switch to which a gateway or hosts are connected.

For the purposes of the present disclosure, the term “a host” is intended to represent any system running an operating system to provide services to applications, as well as any system that communicates with other hosts using the default gateway. Embodiments of a host include both physical servers and virtual machines.

The present aspect includes a method and apparatus to redistribute traffic through the alternative default gateway without modifying any of the hosts in the LAN.

An example by which embodiments of the present disclosure could operate are as follows:

Step-1: The networks existing switch port, which is associated with the original default gateway, is disabled.

In this embodiment, each host and the default gateway connect using a Layer-2 switch; accordingly upon disabling the switch, all traffic from the hosts via the default gateway is dropped.

Step-2: The alternative default gateway is introduced. In one embodiment, the alternative default gateway is introduced with same IP address as the original default gateway. In a further embodiment, the alternative default gateway broadcasts a gratuitous address resolution protocol (“ARP”) to inform the hosts about the change in MAC address for the IP address associated with the gateway. All the existing hosts that receive the ARP packet hen update their ARP tables with the new MAC address.

Performance of the above steps results in all the traffic from the hosts being redirected from the default gateway to the alternative default gateway

In a further embodiment of the present aspect, an additional Step-3 is performed. In this step, the data path connected to the original default gateway is disabled.

In yet a further embodiment of the present aspect, an additional Step-4 is performed, wherein the original default gateway is shutdown.

Embodiments of the present disclosure enable seamless upgrade of default gateway to be performed without impacting upon existing hosts. Embodiments of the present aspect achieve this seamless upgrade by introducing a temporary (alternative) default gateway while upgrading the software on the original default gateway. Upon completion of the default gateway upgrade, the original default gateway can be restored.

A further embodiment of the present aspect enables a virtual services gateway.

An exemplary application of the present aspect is as follows:

In the private and public cloud deployments that are built using VMware hypervisor, a management application such as VMware vCloud Director (“vCD”) will instantiate a VMware vShield Edge Gateway as soon as a cluster of VM are instantiated. The VMware vShield Edge Gateway provides functions such as DHCP, NAT, DNS and Firewall Services for all the virtual machines. However, customers who wish to deploy any virtual services gateways from other vendors such as Cisco Virtual Security Gateway (“VSG”), Cisco Cloud Services Router (“CSR”) or Cisco Virtual ASA (ASA 1000v), could employ embodiments of the present aspect to disable the existing vShield. Edge and reroute traffic through the alternative default gateway.

A further aspect of the present disclosure provides a method and apparatus for conserving VLANs in a date center network.

This aspect discloses a means of conserving a networks' VLANs by extending the L3 domain to Host by running a virtual router on the Host.

By way of explanation, a router's outside interface is on a EEVLAN, inside interface is configured with a ‘Local VLAN’ which is only configured on a single Host, and is not extended up to the distribution layer. A range of VLANs are reserved for Local VLANs. The number of such VLANs need not be more than (number of VMs)/2 that can run on a single Host. The assumption here is for every tenant network, it will need at least 1 service VM for a router and at minimum one application VM. So if the average number of VMs is N, only N/2 number of VLANs need to be reserved for LVLAN.

When a tenant network is created, one of the VLAN ID from the reserved LVLAN range is allocated. These LVLANs can be reused on any other server.

In one embodiment, the VMs connected to the network are localized to a single physical Host. In a further embodiment, to accommodate more VMs the tenants network spans across Hosts, and these VLANs extend up to the access switch to which the Hosts are connected. To accommodate such need, additional reserved ranges can be set aside. In a further embodiment, Hosts are then grouped into multiple groups. In yet a further embodiment, a Host belongs to a single group with a Group comprising one or more Hosts. In yet a further embodiment, the Size of the Host group can be uniform determined by the Administrator, ex. if a Host can run N number of VMs, and Administrator sets a maximum number (M) of VMs per tenant network, then the Host group size can be determined by those constraints, such as (M/(N+1)). The Host groups can also be determined dynamically at the time of allocation of Host to a tenant VM. When a tenant VM (thus the associated network) is placed on a Host, a VLAN ID from the reserved range is allocated. The same VLAN ID can be used to create a tenant network on different Group of Hosts.

This disclosure describes, and illustrates, various embodiments of the invention to with some variations of the various embodiments. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect

What is claimed is:

1. A method for allocating a plurality of computer associated resources in a cloud, the method comprising:
assigning a rank to a subset of said plurality of computer associated resources relative to a second subset of plurality of computer associated resources;
receiving a request for a portion of said plurality of computer associated resources;
allocating a portion of said plurality of computer associated resources in response to said request, said allocation on the basis of a determination criteria.

2. The method of claim 1, wherein said determination criteria comprises:
best fit analysis;
worst fit;
random fit; and
round robin allocation.

3. A method for redirecting traffic through an alternative data path without modifying the configuration of a host connected to an original gateway, said method comprising the steps of:
disabling a first switch port, said first switch port associated with said first gateway;
broadcasting an Address Resolution Protocol by a second gateway; and
updating said host's Address Resolution Protocol table on the basis of a new network address contained with said broadcast for transmission of all traffic from said host via said second gateway.

4. The method of claim 3, further comprising:
disabling said first switch port; and
disabling said first gateway.

5. A method of extending the VLAN capacity of a cloud network, comprising:
configuring a L3 Domain as a host by running a virtual router on said host.

6. A method for designing a network service, the method comprising:
aggregating a list of services, wherein said services are located as part of a network;
establishing the associated parameters, capabilities, and limitations of said services;
presenting said list of services on a GUI interface;
receiving a selection comprising a portion of said list services; and
computing and establishing network path for said selection.
